(19) United States
(12) Patent Application Publication
(10) Pub. No.: US 2012/0050277 A1
(43) Pub. Date: Mar. 1, 2012

(54) STEREOSCOPIC IMAGE DISPLAYING METHOD AND DEVICE

(75) Inventors: Dai MURAKOSHI, Kanagawa (JP); Toshitaka AGANO, Kanagawa (JP)

(73) Assignee: FUJIFILM CORPORATION, Tokyo (JP)

(21) Appl. No.: 13/215,444

(22) Filed: Aug. 23, 2011

(30) Foreign Application Priority Data
Aug. 24, 2010 (JP) 2010-187000

(51) Int. Cl. G06F 3/033; G06T 15/00

(52) U.S. Cl. 345/419; 345/157

(57) ABSTRACT

A stereoscopic image displaying device enables the stereoscopic view of a stereoscopic cursor to be restored while maintaining the stereoscopic view of a region of interest even in a state where the stereoscopic cursor cannot be viewed stereoscopically. The stereoscopic image displaying device includes a stereoscopic cursor moving unit that moves the stereoscopic cursor in a depth direction and an in-plane direction in response to a movement instruction input; a reference position setting unit in which a reference position in the depth direction and the in-plane direction is set in advance; and a stereoscopic cursor reference position moving unit that moves the stereoscopic cursor moved by the stereoscopic cursor moving unit to the reference position in response to a reference position movement input.

### BACKGROUND OF THE INVENTION

1. Field of the Invention

The present invention relates to a stereoscopic image displaying method and device for displaying a stereoscopic image that can be viewed stereoscopically using a plurality of images acquired by radiating a subject in different radiating directions and displaying a stereoscopic cursor that can be moved in the depth direction and an in-plane direction of the displayed stereoscopic image.

2. Description of the Related Art

In the related art, a device which combines and displays a plurality of images so as to be viewed stereoscopically using parallax is known. Such an image (hereinafter a stereoscopic image or a stereo image) that can be stereoscopically viewed is generated based on a plurality of images with parallax, acquired by imaging the same subject from different directions.

Moreover, such way of generating stereoscopic image is utilized not only in the field of digital cameras and televisions but also in the field of radiography. That is, a subject is irradiated with radiation from different directions, the radiation passing through the subject is detected by a radiological image detector to acquire plural radiological images having parallax, and a stereoscopic image is generated based on the radiological images. By generating a stereoscopic image in this way, a radiological image with a sense of depth can be observed and thereby more suitable radiological image for diagnosis can be observed.

In diagnostic interpretation of radiological images, it is helpful to display a stereoscopic image when observing a region of interest, particularly, such as the bone or the blood vessel, of which the distribution in the anatomical-depth direction and such as a tuber or a tumor mass, expansion of which in the depth direction is observed.

When displaying such a stereoscopic image, a stereoscopic cursor is often used in order to allow an observer to intuitively identify the positional relationship in the depth direction or perform quantitative measurement through stereoscopic measurement.

### SUMMARY OF THE INVENTION

However, in a perspective image, in particular, such as a radiological image for diagnosis, since the stereoscopic cursor is displayed within the subject image on which the stereoscopic cursor is superimposed in the depth direction, it is very difficult to stereoscopically recognize the stereoscopic cursor and recognize the position of the stereoscopic cursor in the depth direction. In particular, when the stereoscopic cursor is moved to a position distant from a region of interest that the observer is gazing on, it is difficult to stereoscopically view the stereoscopic cursor and recognize the position of the stereoscopic cursor in the depth direction.

JP-S63-257784A (JP 1988-257784A) discloses a technique in which a reference symbol is provided separately from a pointer symbol, and the reference symbol and the pointer symbol are connected by a connecting symbol so that the position of the stereoscopic cursor within a stereoscopic image can be recognized quickly and accurately. Here, the reference symbol is on a so-called non-parallax plane on a display screen which is a focal plane, whereby the cursor can be easily recognized.

However, most lesions are not present on the non-parallax plane but present at positions distant from each other in the depth direction. Thus, through diagnostic interpretation of radiological images it is very difficult to stereoscopically identify the positional relationship between anatomical landmarks such as bones or vessels and lesions as well as stereoscopically identifying the stereoscopic cursor which is not present on a non-parallax plane but present at a position distant in the depth direction to identify the position in the depth direction.

The present invention has been made in view of the above-mentioned problems and an object of the present invention is to provide a stereoscopic image displaying method and device capable of restoring the stereoscopic view of a stereoscopic cursor while maintaining the stereoscopic view of a region of interest even in a state where the stereoscopic cursor cannot be viewed stereoscopically and appropriately recognizing the position of the stereoscopic cursor in the depth direction.

According to an aspect of the present invention, there is provided a stereoscopic image displaying method of displaying a stereoscopic image that can be viewed stereoscopically using images in each different radiating direction, acquired by radiating a subject in the different directions and displaying a stereoscopic cursor that can be moved in the depth direction and an in-plane direction of the displayed stereoscopic image, the method including: allowing the stereoscopic cursor to move in the depth direction and the in-plane direction in response to a movement instruction input and setting a reference position in the depth direction and the in-plane direction in advance; and moving the moved stereoscopic cursor to the reference position when a reference position movement input is received.

According to another aspect of the present invention, there is provided a stereoscopic image displaying device including: a display unit that displays a stereoscopic image that can be viewed stereoscopically using images in each different radiating direction, acquired by radiating a subject in the different directions; and a stereoscopic cursor display control unit that causes the display unit to display a stereoscopic cursor that can be moved in the depth direction and an in-plane direction of the stereoscopic image displayed on the display unit, wherein the stereoscopic cursor display control unit includes: a stereoscopic cursor moving unit that moves the stereoscopic cursor in the depth direction and the in-plane direction in response to a movement instruction input; a reference position setting unit in which a reference position in the depth direction and the in-plane direction is set in advance; and a stereoscopic cursor reference position moving unit that moves the stereoscopic cursor moved by the stereoscopic cursor moving unit to the reference position in response to a reference position movement input.

In the stereoscopic image displaying device of the above aspect of the present invention, the stereoscopic cursor display control unit may display the stereoscopic cursor using a left-eye cursor image and a right-eye cursor image.

The stereoscopic cursor moving unit may move the stereoscopic cursor in the depth direction by changing an amount of relative shift in a left and right direction between the left-eye cursor image and the right-eye cursor image on a display surface according to the movement instruction input.

The stereoscopic cursor moving unit may move the stereoscopic cursor in the in-plane direction by changing the positions of the left-eye cursor image and the right-eye cursor image displayed on a display surface according to the movement instruction input in a state where an amount of relative shift in the left and right directions between the left-eye cursor image and the right-eye cursor image on the display surface is maintained.

The reference position setting unit may set the reference position in response to the input of coordinate values of the reference position in the depth direction and the in-plane direction.

The reference position setting unit may calculate coordinate information of the reference position in response to the input of information on the reference position.

The information on the reference position may include imaging conditions of the images that constitute the stereoscopic image.

The imaging conditions may include at least one of a distance between an illumination unit that illuminates the subject with illumination light and an imaging unit that captures the images and an angle between an optical axis of the illumination light and an imaging plane of the imaging unit.

The reference position setting unit may set the amount of relative shift in the left and right direction between the left-eye cursor image and the right-eye cursor image based on observation conditions of the stereoscopic image and coordinate information of the reference position in the depth direction.

The observation conditions may include at least one of the interpupillary distance of an observer observing the stereoscopic image and the distance between a combined focal point of both eyes of the observer and a display surface of the display unit.

The images that constitute the stereoscopic image may be radiological images that are acquired by irradiating the subject with radiations.

The images that constitute the stereoscopic image may be radiological images that are acquired by irradiating the subject with radiations, and the reference position setting unit may calculate the coordinate information of the reference position based on at least one of thickness information of the subject in the depth direction and imaging conditions of the radiological image.

The imaging conditions may include at least one of a distance between the radiation source that irradiates the subject and an angle between a radiation axis of the radiations and an imaging plane of the radiological image detector.

The reference position setting unit may set the position of an anatomical structure displayed in the radiological image as the reference position.

The reference position setting unit may set the reference position in response to a designation of the position of the anatomical features by an observer.

The reference position setting unit may set the reference position by automatically recognizing the position of the specific anatomical structure based on the radiological image.

The reference position setting unit may set the position of a marker image displayed in the radiological image as the reference position.

The reference position setting unit may set the reference position in response to a designation of the position of the marker image by an observer.

The reference position setting unit may set the reference position by automatically recognizing the position of the marker image.

The display unit may include a left-eye display unit that displays a left-eye image of the subject and the left-eye cursor image and a right-eye display unit that displays a right-eye image of the subject and the right-eye cursor image, the left-eye display unit and the right-eye display unit being separated from each other.

The stereoscopic image displaying device may include a reference position display control unit that displays the reference position set in the reference position setting unit on the display unit.

The reference position display control unit may switch the reference position displayed or not.

The reference position display control unit may display the reference position with brightness higher than the display of positions other than the reference position.

The reference position display control unit may display the reference position in a color different from the color of images other than at the reference position.

The stereoscopic image displaying device may include a wheel mouse having a scroll wheel, and the stereoscopic cursor moving unit may receive a movement instruction to move the stereoscopic cursor in the depth direction by receiving the input of a scroll operation of the scroll wheel.

According to the stereoscopic image displaying method and device of the above aspects of the present invention, the stereoscopic cursor is allowed to move in the depth direction and the in-plane direction in response to the movement instruction input, the reference position in the depth direction and the in-plane direction is set in advance, and the moved stereoscopic cursor is moved to the reference position when the reference position movement input is received. For example, when an observer sets a position where the observer can easily see the stereoscopic cursor stereoscopically as the reference position, even when it is not possible to provide the stereoscopic view of the stereoscopic cursor during the displaying, by returning the stereoscopic cursor to the reference position, it is possible to restore the stereoscopic view of the stereoscopic cursor while maintaining the stereoscopic view of the region of interest. Thus, the observer can appropriately recognize the position of the stereoscopic cursor in the depth direction.

### BRIEF DESCRIPTION OF THE DRAWINGS

FIG. 1 is a diagram showing a simplified configuration of a radiological stereoscopic imaging display system using an embodiment of a stereoscopic image imaging display device of the present invention.

FIG. 2 is a block diagram showing the internal configuration of a radiation detection unit and a computer of the radiological stereoscopic image displaying system using an embodiment of the stereoscopic image displaying device of the present invention.

FIG. 3 is a perspective view showing an example of a wheel mouse.

FIG. 4 is a block diagram showing a specific configuration of a display control unit.

FIG. 5 is a schematic view showing an example of a stereoscopic cursor.

FIG. 6 is a view illustrating a method of calculating an amount of relative shift in the left and right direction between a left-eye cursor image and a right-eye cursor image based on a reference position RP.

FIG. 7 is a view illustrating an example of calculating the coordinate information of a reference position based on imaging conditions.

FIGS. 8A and 8B are views illustrating a case of setting a part of a costal bone as the reference position RP.

FIG. 9 is a view illustrating a method of setting a part of a costal bone as the reference position.

FIGS. 10A and 10B are views illustrating a case of setting the position of a papilla of a breast as the reference position RP.

FIG. 11 is a view illustrating a method of setting the position of the papilla of a breast as the reference position.

### DESCRIPTION OF THE PREFERRED EMBODIMENTS

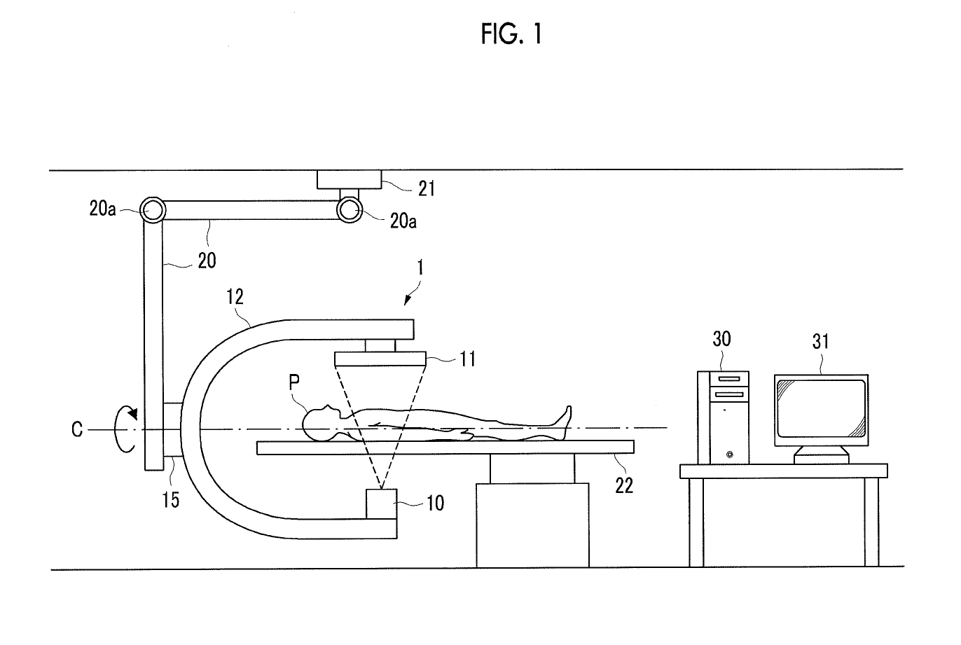

Hereinafter, a radiological stereoscopic image displaying system using an embodiment of a stereoscopic image displaying device according to the present invention will be described with reference to the drawings. A radiological stereoscopic image displaying system according to the present embodiment features in the method of displaying a stereoscopic cursor. First, a simplified configuration of the overall radiological stereoscopic image displaying system will be described. FIG. 1 is a diagram showing a simplified configuration of the radiological stereoscopic image displaying system.

As shown in FIG. 1, the radiological stereoscopic image displaying system includes an imaging device 1 that captures a radiological image of a patient P, a bed 22 which is a supporting table for supporting the patient P, a computer 30 connected to the imaging device 1 so as to control the imaging device 1 and process the radiological image signals acquired through imaging, and a display unit 31 connected to the computer 30.

The imaging device 1 includes a radiation source 10 that emits radiation with a cone-shaped divergence towards the subject, a radiation detection unit 11 that detects the radiations emitted from the radiation source 10, a C-arm 12 that holds the radiation source 10 and the radiation detection unit 11 attached to the respective ends thereof, a rotation driving unit 15 that rotates the C-arm 12, and an arm 20 that holds the rotation driving unit 15.

The C-arm 12 is attached to the rotation driving unit 15 so as to be rotatable 360° about a rotation axis C. Moreover, the arm 20 includes steering portions 20a and is held by a base portion 21 which is provided on the ceiling so as to be movable. The C-arm 12 is configured such that it can widely move in the imaging room by moving the base portion 21, and can change its angle of rotation axis by steering the steering portions 20a of the arm 20.

The radiation source 10 and the radiation detection unit 11 are disposed to face each other with the rotation axis C disposed therebetween. When performing stereoscopic radiological imaging, the C-arm 12 is rotated by a predetermined angle of convergence by the rotation driving unit 15 in a state where the positional relationship between the rotation axis C, the radiation source 10, and the radiation detection unit 11 is fixed.

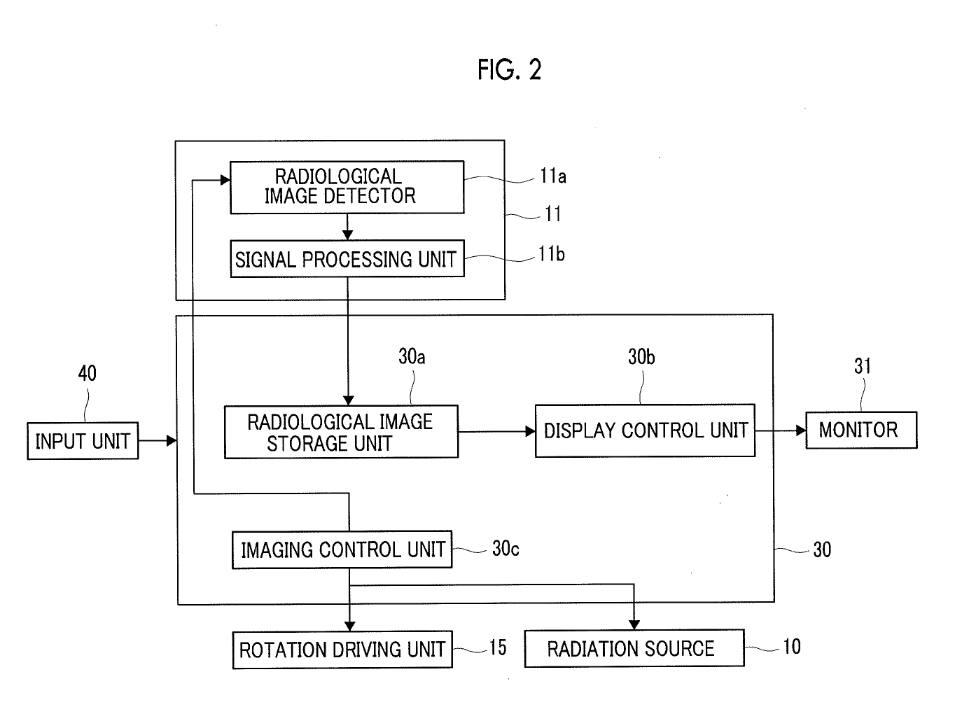

FIG. 2 shows a block diagram of a simplified internal configuration of the radiation detection unit 11 and the computer 30.

As shown in FIG. 2, the radiation detection unit 11 includes a radiological image detector 11a that generates charges in response to irradiation of the radiations having passed through the patient P to thereby output a radiological image signal representing the radiological image of the patient P and a signal processing unit 11b that performs predetermined signal processing on the radiological image signal output from the radiological image detector 11a.

The radiological image detector 11a is configured to repeatedly record and read the radiological images. As the radiological image detector 11a, a so-called direct-conversion type radiological image detector that directly converts the irradiation of radiations into signal charges, or a so-called indirect conversion type radiological image detector that converts radiations into visible light and then converts the visible light into signal charges may be used. Moreover, although a so-called TFT readout method in which TFT (Thin Film Transistor) switches are tuned on and off, whereby radiological image signals are read is preferably used as a method of reading the radiological image signal, the readout method is not limited to this.

The signal processing unit 11b includes an amplification unit made up of a charge amplifier that converts the charge signals read from the radiological image detector 11a into a voltage signal and an AD conversion unit that converts the voltage signal output from the amplification unit into a digital signal.

The computer 30 includes a central processing unit (CPU) and a storage device such as a semiconductor memory, a hard disk, or a SSD, and this hardware forms a radiological image storage unit 30a, a display control unit 30b, and an imaging control unit 30c.

The radiological image storage unit 30a stores two radiological image signals in advance which constitute the stereoscopic image detected by the radiation detection unit 11.

The display control unit 30b generates a display control signal based on the two radiological image signals read from the radiological image storage unit 30a and outputs the display control signal to the display unit 31 to cause the display unit 31 to display a stereoscopic image based on the two radiological image signals. Moreover, the display control unit 30b causes the display unit 31 to display a stereoscopic cursor that is movable in the depth direction and the in-plane direction of the stereoscopic image displayed on the display unit 31. The stereoscopic cursor is used to specify a arbitrary position within the stereoscopic image, acquire information on the specified position, and perform diverse processing on the specified position. Examples of the information on the specified position include the distance information between two specified positions.

The imaging control unit 30c controls the rotation operation of the C-arm 12 by the rotation driving unit 15, the irradiation timing of the radiations emitted from the radiation source 10, and the readout of the radiological image signals from the radiological image detector 11a.

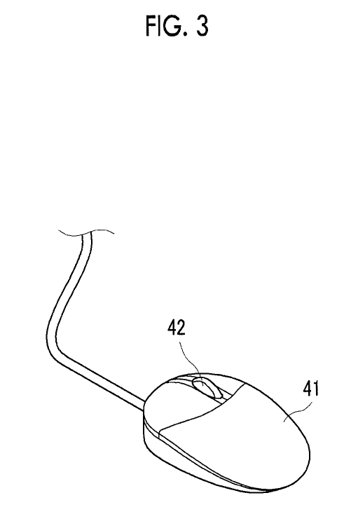

The input unit 40 receives the inputs such as the imaging conditions or the observation conditions of the observer and the inputs relating to operation instructions. The input unit 40 is realized by an input device such as, for example, a keyboard or a mouse. In particular, in the present embodiment, a wheel mouse 41 shown in FIG. 3 is used as one which moves the position of the stereoscopic cursor in the depth direction. The wheel mouse 41 includes a scroll wheel 42, and the position of the stereoscopic cursor in the depth direction is changed by the observer scrolling the scroll wheel 42.

The display unit 31 is configured to display a stereoscopic image using the two radiological image signals output from the computer 30. As the configuration of the display unit 31, for example, a configuration may be adopted in which radiological image signals based on two radiological image signals are displayed using two monitors so that one radiological image is made incident on the right eye of the observer and the other radiological image is made incident on the left eye of the observer by using a semi-transparent mirror and polarized glasses to thereby displaying a stereoscopic image. Alternatively, for example, a configuration may be adopted in which two radiological images are displayed to be superimposed on each with a predetermined amount of shift (amount of parallax), and these images are observed with polarized glasses to thereby generate a stereoscopic image. Furthermore, a configuration may be adopted in which like a parallax barrier method and a lenticular method, two radiological images are displayed on a 3D display capable of providing a stereoscopic view to thereby generate a stereoscopic image.

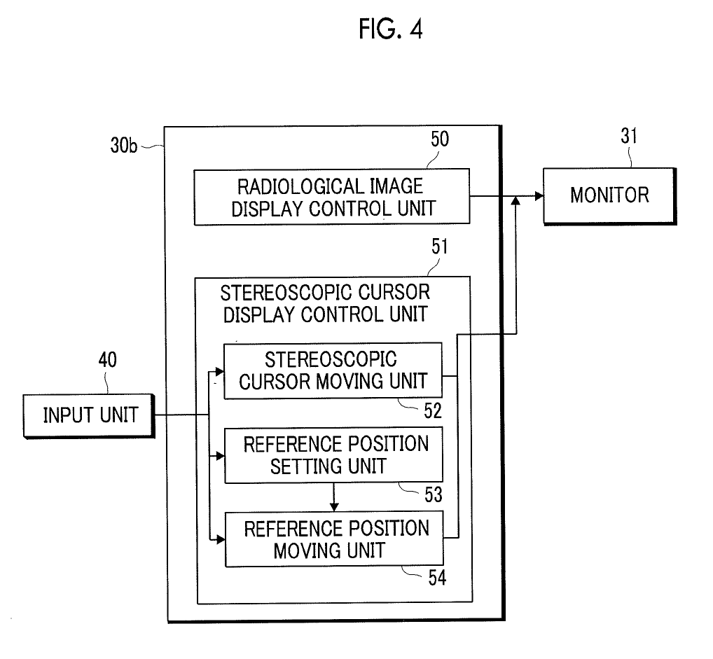

Here, a more specific configuration of the display control unit 30b is shown in FIG. 4. As shown in FIG. 4, the display control unit 30b includes a radiological image display control unit 50 that causes the display unit 31 to display a stereoscopic image based on the two radiological image signals read from the radiological image storage unit 30a and a stereoscopic cursor display control unit 51 that causes the display unit 31 to display the stereoscopic cursor.

The stereoscopic cursor display control unit 51 generates a right-eye cursor image signal and a left-eye cursor image signal which constitute the stereoscopic cursor and displays these signals on respective two monitors of the display unit 31, for example, to thereby display a stereoscopic cursor which can be viewed stereoscopically. The right-eye cursor image signal and the left-eye cursor image signal are generated so as to have an amount of relative shift in the left and right direction.

The stereoscopic cursor display control unit 51 includes a stereoscopic cursor moving unit 52, a reference position setting unit 53, and a reference position moving unit 54.

The stereoscopic cursor moving unit 52 moves the stereoscopic cursor displayed on the display unit 31 in the depth direction and the in-plane direction of the stereoscopic image in accordance with a movement instruction input from the input unit 40 by the observer. Here, the in-plane direction means a direction within the plane orthogonal to the depth direction. When the depth direction is the Z direction, the in-plane direction means a direction within the X-Y plane orthogonal to the Z direction.

Specifically, the stereoscopic cursor moving unit 52 moves the stereoscopic cursor in the depth direction by changing the amount of relative shift in the left and right direction between the right-eye cursor image signal and the left-eye cursor image signal in accordance with the movement instruction input from the input unit 40. Moreover, the stereoscopic cursor moving unit 52 moves the stereoscopic cursor in the in-plane direction by changing the displayed positions of the right-eye cursor image and the left-eye cursor image in the left and right direction and the up and down direction in accordance with the movement instruction input from the input unit 40 in a state where the amount of relative shift in the left and right direction between the right-eye cursor image signal and the left-eye cursor image signal is maintained.

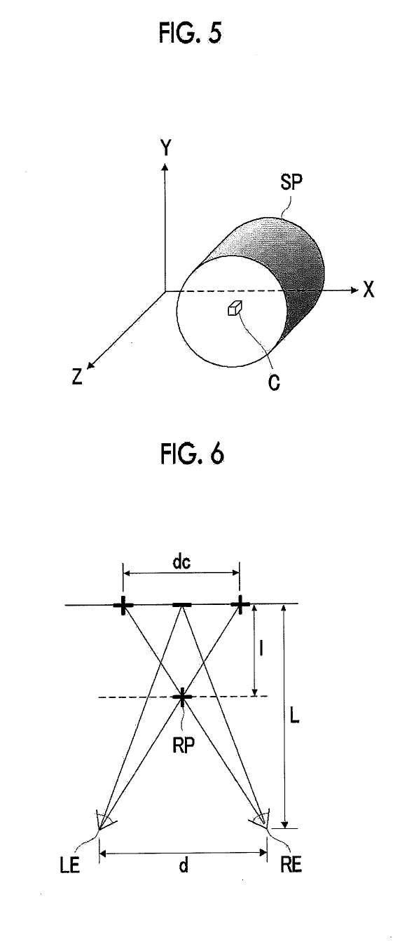

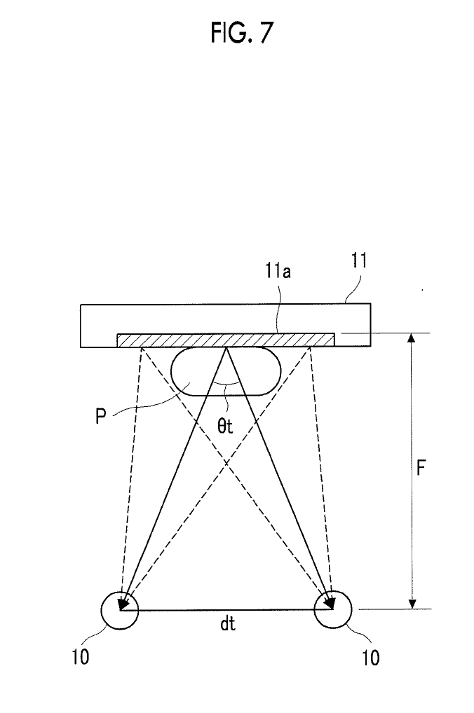

Here, a schematic view of a display example of the stereoscopic cursor is shown in FIG. 5. In FIG. 5, “SP” is a schematic representation of a stereoscopic image SP displayed on the display unit 31, acquired by imaging the patient P, and “C” is a stereoscopic cursor. The stereoscopic cursor C is moved in the X, Y, and Z directions by the stereoscopic cursor moving unit 52 in accordance with the movement instruction input from the input unit 40 by the observer.

As described above, since the stereoscopic cursor C is displayed within the radiological image on which the stereoscopic cursor C is superimposed in the depth direction, it is very difficult to recognize the stereoscopic cursor C stereoscopically and recognize the position of the stereoscopic cursor C in the depth direction. In particular, when the stereoscopic cursor C is moved to a position distant from a region of interest that the observer is focusing on, it is difficult to stereoscopically view the stereoscopic cursor C and recognize the position of the stereoscopic cursor in the depth direction.

Thus, in the present embodiment, when the observer makes a predetermined reference position movement input from the input unit 40, the stereoscopic cursor C is forcibly moved to a reference position which is set in advance. The predetermined reference position movement input for moving the stereoscopic cursor C to the reference position may be input by the observer, for example, using an input device such as a keyboard or a mouse and may be input by the observer designating an icon which is displayed on the screen. Furthermore, this forced movement may occur when a stereoscopic image is changed to another one.

The reference position is a position which is set in advance by the observer and which is set to a position such that the observer can easily identify the position in the depth direction.

The coordinate information of the reference position is set in advance in the reference position setting unit 53. The reference position setting unit 53 calculates the amount of relative shift dc in the left and right direction between the left-eye cursor image signal and the right-eye cursor image signal when displaying the stereoscopic cursor at the reference position based on Equation (1) below.

dc−1×d/(L−1) (1)

In Equation (1), “d” is the distance between the right eye RE and the left eye LE of the observer shown in FIG. 6, and “L” is the distance between the observer and a display surface of the display unit 31. Here, the values “d” and “L” are set and input in advance. Moreover, “1” represents the amount of protrusion of the reference position RP from the display surface of the display unit 31, and the value of “1” can be arbitrarily set by the observer.

The reference position setting unit 53 acquires the value of “1” set by the observer, for example, and calculates the amount of relative shift dc between the left-eye cursor image signal and the right-eye cursor image signal by Equation (1) above based on the value of “1” and the values of “d” and “L” which are set and input in advance. Moreover, the reference position setting unit 53 calculates the coordinate information corresponding to the reference position RP between the left-eye cursor image signal and the right-eye cursor image signal based on the coordinate information of the reference position RP in the in-plane direction and outputs these values to the reference position moving unit 54. In addition, the coordinate information of the reference position RP in the in-plane direction may be arbitrarily set by the observer, for example.

Here, in the above description, since the amount of protrusion of the reference position RP is arbitrarily input by the observer, the observer can set the reference position RP at a desired optional position in accordance with a personal stereoscopic ability or the like. The method of setting the amount of protrusion “1” of the reference position RP is not limited to this method. For example, the amount of protrusion of a predetermined position of a subject displayed as a stereoscopic image may be calculated, and the amount of protrusion may be set as the amount of protrusion “1” of the reference position RP. Hereinafter, a method of calculating the amount of protrusion of a predetermined position of the subject will be described.

First, in general, the amount of protrusion “1′” of a subject when displaying a stereoscopic image is proportional to an observation distance and can be expressed by Equation (2) below.

1′=L×di/(di+d) (2)

Here, “di” is the amount of shift between the left and right display image and “d” is an interpupillary distance of the observer.

The “di” can be acquired by Equation (3) below from the amount of shift “dp” in the left and right direction between the captured images and a display magnification of the monitor. Here, “Pd” is a pixel size of a detector, “Pm” is a pixel size of a monitor, and “M” is a plain magnification ratio of the images.

di==M×dp×Pd/Pm (3)

In Equation (3) above, “dp” is calculated by Equation (4) below from FID(F), the angle of convergence (θt) of the radiation source 10, and the body thickness (D) of the subject P. Here, FID is the distance between the radiation source 10 and the detector.

dp−D×dt/(F−D) (4)

dt=2×F×tan(θt/2) (5)

The angle of convergence θt of the radiation source 10 is set in advance so that the parallax angle when displaying a stereoscopic image is smaller than 2°, for example (the parallax angle is the difference between the angle of convergence when stereoscopically viewing the rear side and the angle of convergence when stereoscopically viewing the front side). Qualitatively, when the subject is thick, the amount of protrusion “1′” increases, and the angle of convergence θt should be set to a small value.

In this way, the amount of protrusion “1′” when displaying a stereoscopic image can be calculated by Equations (2), (3), (4), and (5) based on the imaging geometry (imaging conditions) which includes FID(F), the angle of convergence (θt) of the radiation source 10 and the body thickness (D) of the subject, and an observation distance.

Therefore, for example, when the reference position RP is set to a position on the body surface (with maximum amount of protrusion), the amount of protrusion “1′” calculated in the above-described manner may be set as the amount of protrusion “1” of the reference position RP as it is. Moreover, when the reference position RP is set to the center in the depth (body thickness) of a stereoscopic image, half of the amount of protrusion “1′” calculated in the above-described manner may be set as the amount of protrusion “1” of the reference position RP.

When the amount of protrusion “1′” is calculated in the above-described manner, the information on the imaging geometry (imaging conditions) and the depth (D) of the subject may be included in the header information of the captured radiological image data, for example. In this case, the reference position setting unit 53 may acquire these sets of information from the header information to calculate the amount of protrusion “1” of the reference position RP and calculate the amount of shift dc between the left-eye cursor image signal and the right-eye cursor image signal based on the amount of protrusion “1.”

The present invention is not limited to this, and the imaging geometry information and the body thickness information may be input from the input unit 40. Moreover, when the present invention is applied to stereo mammography, since a compression pad for compressing and holding the breast is used, the thickness information of the breast may be acquired based on the position information of the compression pad.

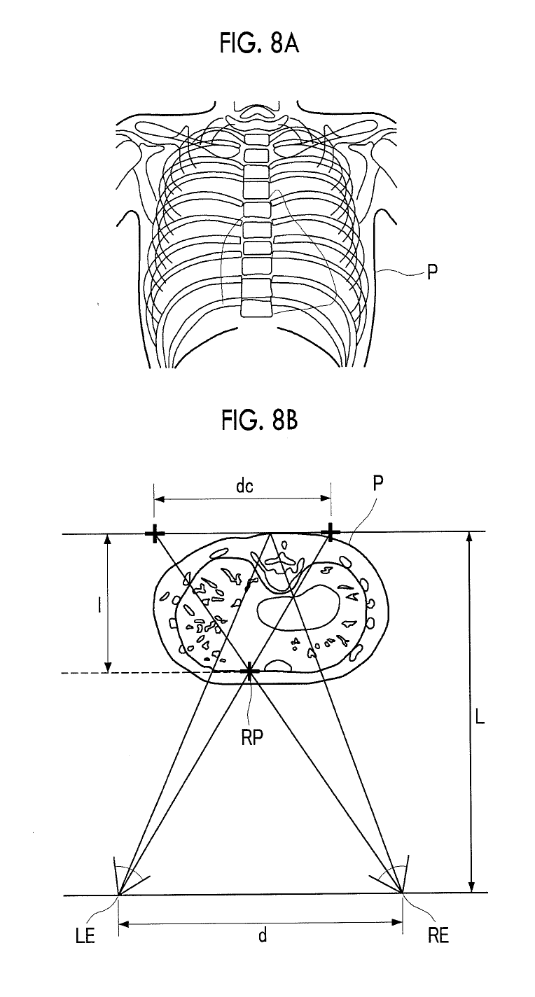

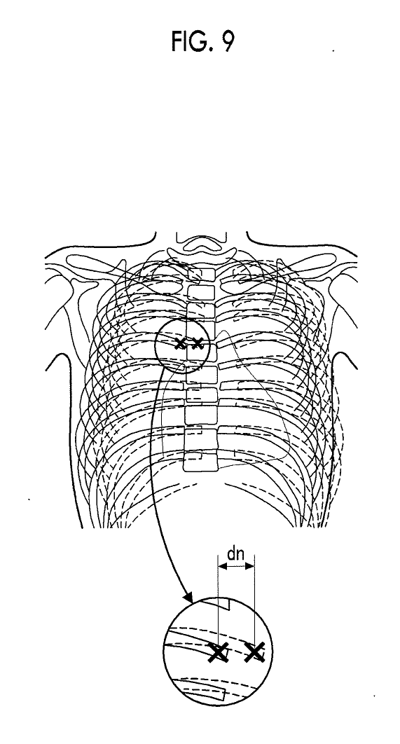

Moreover, when a chest region shown in FIG. 8A is imaged as a subject P, a part of a costal bone may be set as a reference position. For example, when the position of a part of a costal bone shown in FIG. 8B is set as the reference position RP, the observer using the input unit 40 to designate the position of a predetermined position of the corresponding costal bone on a right-eye radiological image (indicated by a solid line) and a left-eye radiological image (indicated by a broken line) displayed on the display unit 31 as shown in FIG. 9, for example. Then, the amount of shift “dn” of the designated position (indicated by an “X” mark) in the left and right direction is acquired. Then, the amount of protrusion “1′” is calculated based on Equation (2) using the amount of shift “dn” as the amount of shift “di” between the left and right display image. The amount of protrusion “1′” is set as the amount of protrusion “1” of the reference position RP. Then, the amount of shift “dc” between the left-eye cursor image signal and the right-eye cursor image signal is calculated based on Equation (1).

In addition, rather than designating a predetermined position of a costal bone using the input unit 40 by the observer as described above, the position of the costal bone may be automatically recognized in accordance with the conditions of image recognition such as recognition of a predetermined pattern.

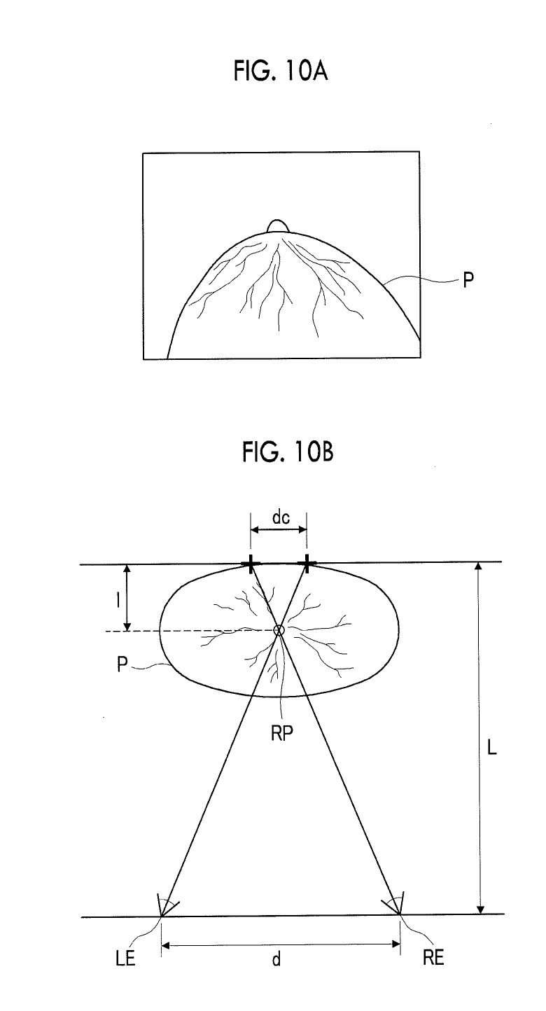

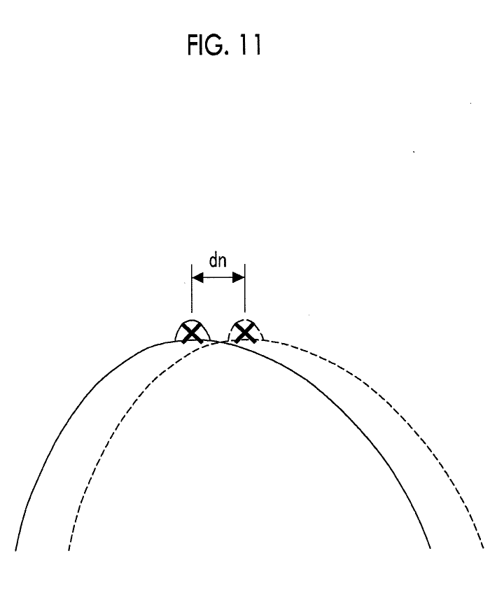

The radiological stereoscopic imaging display system of the present embodiment is designed to image a stereoscopic image of the chest region or the head of a patient. For example, when the present invention is applied to so-called stereo mammography wherein the breast is an imaging target, and the breast shown in FIG. 10A is imaged as the subject P, the papilla position of the breast may be set as the reference position. For example, when the position of a papilla shown in FIG. 10B is set as the reference position RP, the observer using the input unit 40 to designate the position of a corresponding papilla on a right-eye radiological image (indicated by a solid line) and a left-eye radiological image (indicated by a broken line) displayed on the display unit 31 as shown in FIG. 11, for example. Then, the amount of shift “dn” of the designated position (indicated by an “X” mark) in the left and right direction is acquired. Then, the amount of protrusion “1′” is calculated based on Equation (2) using the amount of shift “dn” as the amount of shift “dp” in the left and right direction between the acquired images. The amount of protrusion “1′” is set as the amount of protrusion “1” of the reference position. Then, the amount of shift “dc” between the left-eye cursor image signal and the right-eye cursor image signal is calculated based on Equation (1).

In addition, rather than designating the papilla position using the input unit 40 by the observer as described above, the papilla position may be automatically recognized in accordance with the conditions of image recognition such as recognition of a predetermined pattern. In this case, the amount of protrusion “1′” may be calculated based on Equation (2) using the amount of shift “dn” as the amount of shift “di” in the left and right direction of the captured images.

Moreover, a method of setting a part of the costal bone or the papilla position as the reference position as described above is not limited to one which is based on the input by the observer. For example, a marker formed of a radiation absorbing member may be attached to the body surface of a patient corresponding to a part of the costal bone or the papilla position of the patient, a marker image appearing in the right-eye radiological image and the left-eye radiological image may be automatically detected. Alternatively, the reference position may be set by the observer designating it using the input unit 40. In the method of setting the reference position using a marker, since the marker image may be included in the radiological image of the subject and may result in an obstacle shadow of a diagnostic image. Therefore, the marking position is preferably set to a position on an imaging table on which the subject is placed or on the compressing pad, for example, rather than on the body surface of the subject so that the marker image is not included in the radiological image of the subject.

The reference position moving unit 54 moves the stereoscopic cursor to the reference position based on the coordinate information and the amount of shift corresponding to the reference position RP between the left-eye cursor image signal and the right-eye cursor image signal, calculated by the reference position setting unit 53 in the above-described manner when the predetermined reference position movement input is received from the input unit 40.

Moreover, in order to make the reference position set in the above-described manner easily identifiable, the display control unit 30b may further include a reference position display control unit that displays the reference position as a reference cursor. Moreover, when the reference position display control unit displays the reference cursor, the reference cursor may be displayed with a brightness higher than that of the radiological image other than the reference cursor in order to make the position of the reference cursor easy to be visible. Moreover, the reference cursor may be displayed in a color different from the color of the radiological image other than the reference cursor. For example, when the radiological image is displayed in a combination of black and white, the reference cursor may be displayed in other color different from black and white. Alternatively, the contrast ratio at the boundary between the reference cursor and the surrounding may be increased.

Moreover, the display of the reference cursor may disappear in accordance with an instruction from the input unit 40 so as not to impede diagnosis and may reappear in accordance with an instruction from the input unit 40 as necessary.

Next, the operation of the radiological stereoscopic imaging display system will be described.

First, as shown in FIG. 1, the patient P lies on the bed 22, and the C-arm 12 is positioned such that the radiation source 10 and the radiation detection unit 11 are disposed at symmetrical positions with the rotation axis C disposed therebetween using the approximate center of the body of the patient P as the rotation axis C. The positioning of the C-arm 12 is performed arbitrarily in a desired observation direction of a photographer. In this case, a direction from the radiation source 10 to the radiation detection unit 11 in the positioned state of the C-arm 12 is the depth direction of the stereoscopic image.

Subsequently, the operator inputs various imaging conditions such as the angle of convergence θ using the input unit 40 and then issues an imaging start instruction. In this case, the body thickness information of the patient P, the distance “dt” between the focal spots of the radiation source 10, an imaging distance F, and the like, which are used for calculating the coordinate information of the reference position RP may be input. Moreover, in this case, the operator may input the coordinate values of the reference position RP in the depth direction and the in-plane direction and set the reference position RP.

When the imaging start instruction is issued from the input unit 40, the stereoscopic image of the patient P is imaged. Specifically, first, the imaging control unit 30c acquires the angle of convergence θ input from the input unit 40 and outputs a control signal to the rotation driving unit 15 so that the C-arm 12 positioned at a predetermined position is rotated by +θ° based on the information on the angle of convergence θ. In the present embodiment, ±2° is input as the angle of convergence θ.

Moreover, the C-arm 12 is rotated by +2° in accordance with the control signal output from the imaging control unit 30c. Subsequently, the imaging control unit 30c outputs a control signal to the radiation source 10 and the radiation detection unit 11 so as to emit radiations and read radiological image signals. In accordance with the control signal, radiations are emitted from the radiation source 10, and radiological images of the patient P, imaged from the +2° direction are detected by the radiological image detector 11a. The radiological image signals are read from the radiological image detector 11a, are subjected to diverse signal processing by the signal processing unit 11b, and are then stored in the radiological image storage unit 30a of the computer 30.

Subsequently, the imaging control unit 30c returns the C-arm 12 to the initial position and outputs a control signal to the rotation driving unit 15 so as to rotate the C-arm 12 by −θ°. That is, in the present embodiment, a control signal is output to the rotation driving unit 15 so that the C-arm 12 is rotated by −2°.

Moreover, the C-arm 12 is rotated by −2° in accordance with the control signal output from the imaging control unit 30c. Subsequently, the imaging control unit 30c outputs a control signal to the radiation source 10 and the radiation detection unit 11 so as to emit radiations and read radiological image signals. In accordance with the control signal, radiations are emitted from the radiation source 10, and radiological images of the patient P, imaged from the −2° direction are detected by the radiological image detector 11a. The radiological image signals are read from the radiological image detector 11a, are subjected to diverse signal processing by the signal processing unit 11b, and are then stored in the radiological image storage unit 30a of the computer 30.

Moreover, two radiological image signals are read from the radiological image storage unit 30a by the radiological image display control unit 50 of the display control unit 30b, are subjected to diverse processing, and are then output to the display unit 31. The, the display unit 31 displays a stereoscopic image of the patient P based on the two radiological image signals input thereto.

In this way, the stereoscopic image is displayed on the display unit 31, and the stereoscopic cursor is displayed on the display unit 31 by the stereoscopic cursor display control unit 51.

The observer moves the position of the stereoscopic cursor using the input unit 40 in accordance with the desired purpose while observing the stereoscopic image displayed on the display unit 31.

When the observer feels that it is difficult to identify the position of the stereoscopic cursor in the depth direction, the observer makes a predetermined reference position movement input using the input unit 40, whereby the stereoscopic cursor is moved to the reference position RP in accordance with the input. In this way, when the stereoscopic cursor returns to the reference position RP set in advance, the observer can easily identify the position of the stereoscopic cursor in the depth direction. In addition, the method of setting and displaying the reference position RP is as described above.

In the above embodiment, although an embodiment of the stereoscopic image displaying device according to the present invention is applied to a radiological imaging display system for imaging the chest region, the head, or the like, the present invention is not limited to this but may be applied to the above-described stereo mammography.

Moreover, the present invention is not limited to a case of displaying the stereoscopic image of radiological images but can be applied to a case of displaying images captured by other imaging devices such as a digital camera as the stereoscopic image.

What is claimed is:

1. A stereoscopic image displaying method of displaying a stereoscopic image that can be viewed stereoscopically using images in each different radiating direction, acquired by radiating a subject in the different directions and displaying a stereoscopic cursor that can be moved in a depth direction and an in-plane direction of the displayed stereoscopic image, the method comprising:
allowing the stereoscopic cursor to move in the depth direction and the in-plane direction in response to a movement instruction input and setting a reference position in the depth direction and the in-plane direction in advance; and
moving the stereoscopic cursor to the reference position when a predetermined reference position movement input is received.

2. A stereoscopic image displaying device comprising:
a display unit that displays a stereoscopic image that can be viewed stereoscopically using images in each different radiating direction, acquired by radiating a subject in the different directions; and
a stereoscopic cursor display control unit that causes the display unit to display a stereoscopic cursor that can be moved in a depth direction and an in-plane direction of the stereoscopic image displayed on the display unit,
wherein the stereoscopic cursor display control unit includes:
a stereoscopic cursor moving unit that moves the stereoscopic cursor in the depth direction and the in-plane direction in response to a movement instruction input;
a reference position setting unit setting a reference position in the depth direction and the in-plane direction in advance; and
a stereoscopic cursor reference position moving unit that moves the stereoscopic cursor moved by the stereoscopic cursor moving unit to the reference position in response to the predetermined reference position movement input.

3. The stereoscopic image displaying device according to claim 2,
wherein the stereoscopic cursor display control unit displays the stereoscopic cursor using a left-eye cursor image and a right-eye cursor image.

4. The stereoscopic image displaying device according to claim 3,
wherein the stereoscopic cursor moving unit moves the stereoscopic cursor in the depth direction by changing an amount of relative shift in a left and right direction between the left-eye cursor image and the right-eye cursor image on a display surface according to the movement instruction input.

5. The stereoscopic image displaying device according to claim 3,
wherein the stereoscopic cursor moving unit moves the stereoscopic cursor in the in-plane direction by changing the positions of the left-eye cursor image and the right-eye cursor image displayed on a display surface according to the movement instruction input in a state where an amount of relative shift in a left and right direction between the left-eye cursor image and the right-eye cursor image on the display surface is maintained.

6. The stereoscopic image displaying device according to claim 2,
wherein the reference position setting unit sets the reference position in response to the input of coordinate values of the reference position in the depth direction and the in-plane direction.

7. The stereoscopic image displaying device according to claim 2,
wherein the reference position setting unit calculates coordinate information of the reference position in response to the input of information on the reference position.

8. The stereoscopic image displaying device according to claim 7,
wherein the information on the reference position includes radiographing conditions of images that constitute the stereoscopic image.

9. The stereoscopic image displaying device according to claim 8,
wherein the imaging conditions include at least one of a distance between an illumination unit that illuminates the subject with illumination light and an imaging unit that captures the images, and an angle between an optical axis of the illumination light and an imaging plane of the imaging unit.

10. The stereoscopic image displaying device according to claim 3,
wherein the reference position setting unit sets the amount of relative shift in the left and right direction between the left-eye cursor image and the right-eye cursor image based on observation conditions of the stereoscopic image and coordinate information of the reference position in the depth direction.

11. The stereoscopic image displaying device according to claim 10,
wherein the observation conditions include at least one of an interpupillary distance of an observer observing the stereoscopic image and a distance between a combined focal point of both eyes of the observer and a display surface of the display unit.

12. The stereoscopic image displaying device according to claim 2,
wherein images constituting the stereoscopic image are radiological images that are acquired by irradiating the subject with radiations.

13. The stereoscopic image displaying device according to claim 12,
wherein the reference position setting unit calculates the coordinate information of the reference position based on at least one of thickness information of the subject in the depth direction and imaging conditions of the radiological image.

14. The stereoscopic image displaying device according to claim 13,
wherein the imaging conditions include at least one of a distance between the radiation source that irradiates the subject with radiations and the radiological image detector that captures the radiological image, and an angle between a radiation axis of the radiations and an imaging plane of the radiological image detector when capturing the radiological image.

15. The stereoscopic image displaying device according to claim 12,
wherein the reference position setting unit sets the position of a specific anatomical structure displayed in the radiological image as the reference position.

16. The stereoscopic image displaying device according to claim 15,
wherein the reference position setting unit sets the reference position in response to a designation of the position of the specific anatomical structure by an observer.

17. The stereoscopic image displaying device according to claim 15,
wherein the reference position setting unit sets the reference position by automatically recognizing the position of the specific anatomical structure based on the radiological image.

18. The stereoscopic image displaying device according to claim 12,
wherein the reference position setting unit sets the position of a marker image displayed in the radiological image as the reference position.

19. The stereoscopic image displaying device according to claim 18,
wherein the reference position setting unit sets the reference position in response to a designation of the position of the marker image by an observer.

20. The stereoscopic image displaying device according to claim 18,
wherein the reference position setting unit sets the reference position by automatically recognizing the position of the marker image.

21. The stereoscopic image displaying device according to claim 3,
wherein the display unit includes a left-eye display unit that displays a left-eye image of the subject and the left-eye cursor image and a right-eye display unit that displays a right-eye image of the subject and the right-eye cursor image, the left-eye display unit and the right-eye display unit being provided separatelly.

22. The stereoscopic image displaying device according to claim 2,
further comprising a reference position display control unit that displays the reference position set in the reference position setting unit on the display unit.

23. The stereoscopic image displaying device according to claim 22,
wherein the reference position display control unit switches the reference position displayed or not.

24. The stereoscopic image displaying device according to claim 22,
wherein the reference position display control unit displays the reference position with brightness higher than the display of positions other than the reference position.

25. The stereoscopic image displaying device according to claim 22,
wherein the reference position display control unit displays the reference position in a color different from the color of images other than the reference position.

26. The stereoscopic image displaying device according to claim 2,
further comprising a wheel mouse having a scroll wheel,
wherein the stereoscopic cursor moving unit receives a movement instruction to move the stereoscopic cursor in the depth direction by receiving the input of a scroll operation of the scroll wheel.
